(19) United States
(12) Patent Application Publication
(10) Pub. No.: US 2019/0037430 A1
(43) Pub. Date: Jan. 31, 2019

(54) METHOD AND DEVICE FOR REPORTING SIDELINK RESOURCE OCCUPANCY LEVEL IN WIRELESS COMMUNICATION SYSTEM

(71) Applicant: LG Electronics Inc., Seoul (KR)

(72) Inventors: Youngdae LEE, Seoul (KR); Jaewook LEE, Seoul (KR); Hanbyul SEO, Seoul (KR)

(21) Appl. No.: 16/085,842

(22) PCT Filed: Mar. 15, 2017
(86) PCT No.: PCT/KR2017/002776

§ 371 Date: Sep. 17, 2018

Related U.S. Application Data
(60) Provisional application No. 62/317,427, filed on Apr. 1, 2016.
(60) Provisional application No. 62/309,926, filed on Mar. 17, 2016.

(51) Int. Cl. H04W 24/10; H04W 76/14; H04W 40/06; H04W 40/12; H04L 12/26; H04B 17/318; H04W 4/46; H04W 88/04

(52) U.S. Cl. CPC H04W 24/10; H04W 76/14; H04W 40/06; H04W 88/04; H04L 43/0882; H04B 17/318; H04W 4/46; H04W 40/12

(57) ABSTRACT

A user equipment (UE) measures a sidelink (SL) resource occupancy level, and reports the measured SL resource occupancy level to an eNodeB (eNB). The measured SL resource occupancy level may be reported to the eNB when a predetermined event occurs. For example, the predetermined event may be a case in which the measured SL resource occupancy level is greater than or less than a threshold value. The SL resource occupancy level may be referred to as a channel busy ratio (CBR).

### BACKGROUND OF THE INVENTION

### Field of the Invention

The present invention relates to wireless communications and, more particularly, to a method and device for reporting an occupancy of a sidelink (SL) resource in a wireless communication system.

### Related Art

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

LTE-based vehicle-to-everything (V2X) is urgently desired from market requirement as widely deployed LTE-based network provides the opportunity for the vehicle industry to realize the concept of ‘connected cars’. The market for vehicle-to-vehicle (V2V) communication in particular is time sensitive because related activities such as research projects, field test, and regulatory work are already ongoing or expected to start in some countries or regions such as US, Europe, Japan, Korea, and China.

3GPP is actively conducting study and specification work on LTE-based V2X in order to respond to this situation. In LTE-based V2X, PC5-based V2V has been given highest priority. It is feasible to support V2V services based on LTE PC5 interface with necessary enhancements such as LTE sidelink resource allocation, physical layer structure, and synchronization. In the meantime, V2V operation scenarios based on not only LTE PC5 interface but also LTE Uu interface or a combination of Uu and PC5 has been considered. The maximum efficiency of V2V services may be achieved by selecting/switching the operation scenario properly.

Early completion of the corresponding radio access network (RAN) specification for PC5-based V2V and integration with Uu interface will enable fast preparation for device and network implementation, thereby allowing more chance for LTE-based V2V in the market. In addition, it can provide the basis for other V2X services, especially vehicle-to-infrastructure/network (V2I/N) and vehicle-to-pedestrian (V2P) services, so that RAN support for all the V2X services can be completed in time.

### SUMMARY OF THE INVENTION

The present invention provides a method and device for reporting an occupancy of a sidelink (SL) resource in a wireless communication system. The present invention provides improvement of PC5 interface for vehicle-to-everything (V2X) and, more particularly, a method and device for measuring an occupancy of a SL resource of PC5 interface used for V2X communication and reporting the measured occupancy of the SL resource.

In an aspect, a method for reporting an occupancy of a sidelink (SL) resource by a user equipment (UE) in a wireless communication system is provided. The method includes measuring the occupancy of the SL resource, and reporting the measured occupancy of the SL resource to an eNodeB (eNB).

The measured occupancy of the SL resource may be reported to the eNB when a specific event occurs. The specific event may be a case that the measured occupancy of the SL resource is greater than a threshold value or lower than a threshold value.

The measured occupancy of the SL resource may be reported to the eNB periodically.

The occupancy of the SL resource may be measured during a pre-determined interval

The occupancy of the SL resource may be one of an integer from 0 to 100.

The occupancy of the SL resource may be a channel busy ratio (CBR).

The UE may be a vehicle UE.

The method may further include transmitting a vehicle-to-vehicle (V2V) message to another vehicle UE via the SL resource.

The method may further include selecting one path among an uplink (UL) and a SL based on the measured occupancy of the SL resource. The method may further include switching a path based on the selected one path.

The method may further include measuring quality of a sidelink channel, and reporting the measured quality of the sidelink channel to the eNB. The quality of the sidelink channel may be a sidelink reference signal received power (SL-RSRP).

In another aspect, a user equipment (UE) in a wireless communication system is provided. The UE includes a memory, a transceiver, and a processor, operably coupled to the memory and the transceiver, that measures an occupancy of a sidelink (SL) resource, and controls the transceiver to report the measured occupancy of the SL resource to an eNodeB (eNB).

For V2X communication, the use of PC5 interface may be optimized.

### BRIEF DESCRIPTION OF THE DRAWINGS

FIG. 1 shows LTE system architecture.

FIG. 2 shows a block diagram of a user plane protocol stack of an LTE system.

FIG. 3 shows a block diagram of a control plane protocol stack of an LTE system.

FIG. 4 shows mapping between sidelink transport channels and sidelink physical channels.

FIG. 5 shows mapping between sidelink logical channels and Sidelink transport channels.

FIG. 6 illustrates a method of reporting an occupancy of a SL resource according to an embodiment of the present invention.

FIG. 7 illustrates the case where a path of a V2V message is switched according to an embodiment of the present invention.

FIG. 8 illustrates a model for path switching in a UE according to an embodiment of the present invention.

FIG. 9 shows a wireless communication system to implement an embodiment of the present invention.

### DESCRIPTION OF EXEMPLARY EMBODIMENTS

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802-20, evolved UTRA (E-UTRA), etc. IEEE 802.16m is an evolution of IEEE 802.16e, and provides backward compatibility with an IEEE 802.16-based system. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in downlink and uses the SC-FDMA in uplink. LTE-advance (LTE-A) is an evolution of the 3GPP LTE.

For clarity, the following description will focus on the LTE-A. However, technical features of the present invention are not limited thereto.

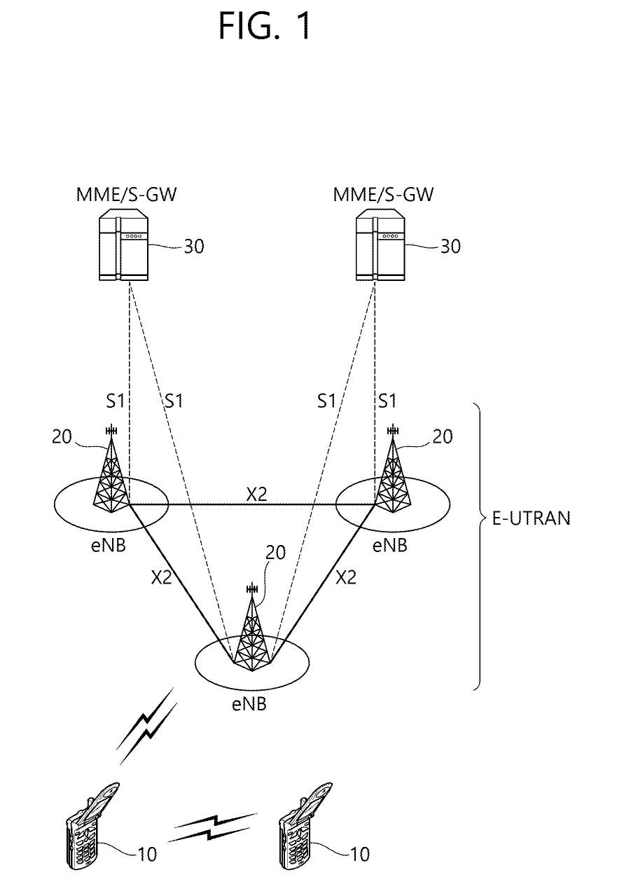

FIG. 1 shows LTE system architecture. Referring to FIG. 1, the LTE system architecture includes one or more user equipment (UE; 10), an evolved-UMTS terrestrial radio access network (E-UTRAN) and an evolved packet core (EPC). The UE 10 refers to a communication equipment carried by a user. The UE 10 may be fixed or mobile, and may be referred to as another terminology, such as a mobile station (MS), a user terminal (UT), a subscriber station (SS), a wireless device, etc.

The E-UTRAN includes one or more evolved node-B (eNB) 20, and a plurality of UEs may be located in one cell. The eNB 20 provides an end point of a control plane and a user plane to the UE 10. The eNB 20 is generally a fixed station that communicates with the UE 10 and may be referred to as another terminology, such as a base station (BS), an access point, etc. One eNB 20 may be deployed per cell.

Hereinafter, a downlink (DL) denotes communication from the eNB 20 to the UE 10. An uplink (UL) denotes communication from the UE 10 to the eNB 20. A sidelink (SL) denotes communication between the UEs 10. In the DL, a transmitter may be a part of the eNB 20, and a receiver may be a part of the UE 10. In the UL, the transmitter may be a part of the UE 10, and the receiver may be a part of the eNB 20. In the SL, the transmitter and receiver may be a part of the UE 10.

The EPC includes a mobility management entity (MME) and a serving gateway (S-GW). The MME/S-GW 30 provides an end point of session and mobility management function for the UE 10. For convenience, MME/S-GW 30 will be referred to herein simply as a “gateway,” but it is understood that this entity includes both the MME and S-GW. A packet data network (PDN) gateway (P-GW) may be connected to an external network.

The MME provides various functions including non-access stratum (NAS) signaling to eNBs 20, NAS signaling security, access stratum (AS) security control, inter core network (CN) node signaling for mobility between 3GPP access networks, idle mode UE reachability (including control and execution of paging retransmission), tracking area list management (for UE in idle and active mode), packet data network (PDN) gateway (P-GW) and S-GW selection, MME selection for handovers with MME change, serving GPRS support node (SGSN) selection for handovers to 2G or 3G 3GPP access networks, roaming, authentication, bearer management functions including dedicated bearer establishment, support for public warning system (PWS) (which includes earthquake and tsunami warning system (ETWS) and commercial mobile alert system (CMAS)) message transmission. The S-GW host provides assorted functions including per-user based packet filtering (by e.g., deep packet inspection), lawful interception, UE Internet protocol (IP) address allocation, transport level packet marking in the DL, UL and DL service level charging, gating and rate enforcement, DL rate enforcement based on access point name aggregate maximum bit rate (APN-AMBR).

Interfaces for transmitting user traffic or control traffic may be used. The UE 10 is connected to the eNB 20 via a Uu interface. The UEs 10 are connected to each other via a PC5 interface. The eNBs 20 are connected to each other via an X2 interface. Neighboring eNBs may have a meshed network structure that has the X2 interface. The eNB 20 is connected to the gateway 30 via an S1 interface.

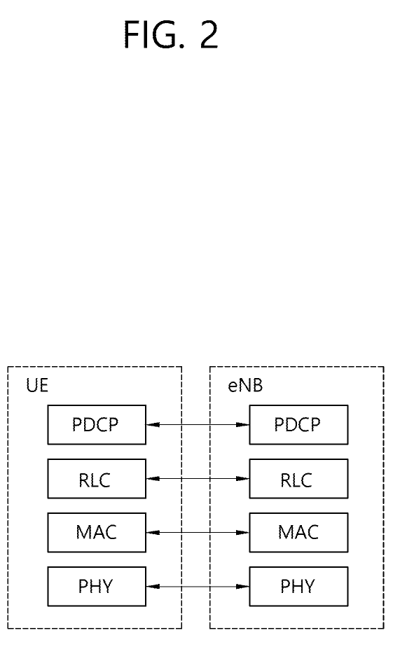

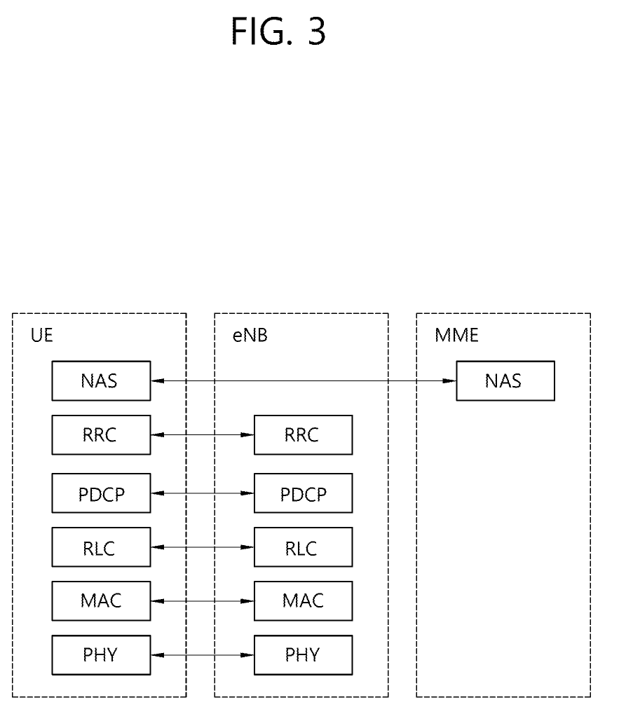

FIG. 2 shows a block diagram of a user plane protocol stack of an LTE system. FIG. 3 shows a block diagram of a control plane protocol stack of an LTE system. Layers of a radio interface protocol between the UE and the E-UTRAN may be classified into a first layer (L1), a second layer (L2), and a third layer (L3) based on the lower three layers of the open system interconnection (OSI) model that is well-known in the communication system.

A physical (PHY) layer belongs to the L1. The PHY layer provides a higher layer with an information transfer service through a physical channel. The PHY layer is connected to a medium access control (MAC) layer, which is a higher layer of the PHY layer, through a transport channel. A physical channel is mapped to the transport channel. Data between the MAC layer and the PHY layer is transferred through the transport channel. Between different PHY layers, i.e., between a PHY layer of a transmission side and a PHY layer of a reception side, data is transferred via the physical channel.

A MAC layer, a radio link control (RLC) layer, and a packet data convergence protocol (PDCP) layer belong to the L2. The MAC layer provides services to the RLC layer, which is a higher layer of the MAC layer, via a logical channel. The MAC layer provides data transfer services on logical channels. The RLC layer supports the transmission of data with reliability. Meanwhile, a function of the RLC layer may be implemented with a functional block inside the MAC layer. In this case, the RLC layer may not exist. The PDCP layer provides a function of header compression function that reduces unnecessary control information such that data being transmitted by employing IP packets, such as IPv4 or Ipv6, can be efficiently transmitted over a radio interface that has a relatively small bandwidth.

A radio resource control (RRC) layer belongs to the L3. The RLC layer is located at the lowest portion of the L3, and is only defined in the control plane. The RRC layer controls logical channels, transport channels, and physical channels in relation to the configuration, reconfiguration, and release of radio bearers (RBs). The RB signifies a service provided the L2 for data transmission between the UE and E-UTRAN.

Referring to FIG. 2, the RLC and MAC layers (terminated in the eNB on the network side) may perform functions such as scheduling, automatic repeat request (ARQ), and hybrid ARQ (HARD). The PDCP layer (terminated in the eNB on the network side) may perform the user plane functions such as header compression, integrity protection, and ciphering.

Referring to FIG. 3, the RLC and MAC layers (terminated in the eNB on the network side) may perform the same functions for the control plane. The RRC layer (terminated in the eNB on the network side) may perform functions such as broadcasting, paging, RRC connection management, RB control, mobility functions, and UE measurement reporting and controlling. The NAS control protocol (terminated in the MME of gateway on the network side) may perform functions such as a SAE bearer management, authentication, LTE_IDLE mobility handling, paging origination in LTE_IDLE, and security control for the signaling between the gateway and UE.

A physical channel transfers signaling and data between PHY layer of the UE and eNB with a radio resource. A physical channel consists of a plurality of subframes in time domain and a plurality of subcarriers in frequency domain. One subframe, which is 1 ms, consists of a plurality of symbols in the time domain. Specific symbol(s) of the subframe, such as the first symbol of the subframe, may be used for a physical downlink control channel (PDCCH). The PDCCH carries dynamic allocated resources, such as a physical resource block (PRB) and modulation and coding scheme (MCS).

A DL transport channel includes a broadcast channel (BCH) used for transmitting system information, a paging channel (PCH) used for paging a UE, a downlink shared channel (DL-SCH) used for transmitting user traffic or control signals, a multicast channel (MCH) used for multicast or broadcast service transmission. The DL-SCH supports HARQ, dynamic link adaptation by varying the modulation, coding and transmit power, and both dynamic and semi-static resource allocation. The DL-SCH also may enable broadcast in the entire cell and the use of beamforming.

A UL transport channel includes a random access channel (RACH) normally used for initial access to a cell, and an uplink shared channel (UL-SCH) for transmitting user traffic or control signals. The UL-SCH supports HARQ and dynamic link adaptation by varying the transmit power and potentially modulation and coding. The UL-SCH also may enable the use of beamforming.

The logical channels are classified into control channels for transferring control plane information and traffic channels for transferring user plane information, according to a type of transmitted information. That is, a set of logical channel types is defined for different data transfer services offered by the MAC layer.

The control channels are used for transfer of control plane information only. The control channels provided by the MAC layer include a broadcast control channel (BCCH), a paging control channel (PCCH), a common control channel (CCCH), a multicast control channel (MCCH) and a dedicated control channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting multimedia broadcast multicast services (MBMS) control information from the network to a UE. The DCCH is a point-to-point bi-directional channel used by UEs having an RRC connection that transmits dedicated control information between a UE and the network.

Traffic channels are used for the transfer of user plane information only. The traffic channels provided by the MAC layer include a dedicated traffic channel (DTCH) and a multicast traffic channel (MTCH). The DTCH is a point-to-point channel, dedicated to one UE for the transfer of user information and can exist in both UL and DL. The MTCH is a point-to-multipoint downlink channel for transmitting traffic data from the network to the UE.

UL connections between logical channels and transport channels include the DCCH that can be mapped to the UL-SCH, the DTCH that can be mapped to the UL-SCH and the CCCH that can be mapped to the UL-SCH. Downlink connections between logical channels and transport channels include the BCCH that can be mapped to the BCH or DL-SCH, the PCCH that can be mapped to the PCH, the DCCH that can be mapped to the DL-SCH, and the DTCH that can be mapped to the DL-SCH, the MCCH that can be mapped to the MCH, and the MTCH that can be mapped to the MCH.

An RRC state indicates whether an RRC layer of the UE is logically connected to an RRC layer of the E-UTRAN. The RRC state may be divided into two different states such as an RRC idle state (RRC_IDLE) and an RRC connected state (RRC_CONNECTED). In RRC_IDLE, the UE may receive broadcasts of system information and paging information while the UE specifies a discontinuous reception (DRX) configured by NAS, and the UE has been allocated an identification (ID) which uniquely identifies the UE in a tracking area and may perform public land mobile network (PLMN) selection and cell re-selection. Also, in RRC_IDLE, no RRC context is stored in the eNB.

In RRC_CONNECTED, the UE has an E-UTRAN RRC connection and a context in the E-UTRAN, such that transmitting and/or receiving data to/from the eNB becomes possible. Also, the UE can report channel quality information and feedback information to the eNB. In RRC_CONNECTED, the E-UTRAN knows the cell to which the UE belongs. Therefore, the network can transmit and/or receive data to/from UE, the network can control mobility (handover and inter-radio access technologies (RAT) cell change order to GSM EDGE radio access network (GERAN) with network assisted cell change (NACC)) of the UE, and the network can perform cell measurements for a neighboring cell.

In RRC_IDLE, the UE specifies the paging DRX cycle. Specifically, the UE monitors a paging signal at a specific paging occasion of every UE specific paging DRX cycle. The paging occasion is a time interval during which a paging signal is transmitted. The UE has its own paging occasion. A paging message is transmitted over all cells belonging to the same tracking area. If the UE moves from one tracking area (TA) to another TA, the UE will send a tracking area update (TAU) message to the network to update its location.

Sidelink is described. Sidelink is a UE to UE interface for sidelink communication and sidelink discovery. The Sidelink corresponds to the PC5 interface. Sidelink communication is AS functionality enabling ProSe direct communication, between two or more nearby UEs, using E-UTRA technology but not traversing any network node. Sidelink discovery is AS functionality enabling ProSe direct discovery, using E-UTRA technology but not traversing any network node. Sidelink uses UL resources and physical channel structure similar to UL transmissions. Sidelink transmission uses the same basic transmission scheme as the UL transmission scheme. However, sidelink is limited to single cluster transmissions for all the sidelink physical channels. Further, sidelink uses a 1 symbol gap at the end of each sidelink subframe.

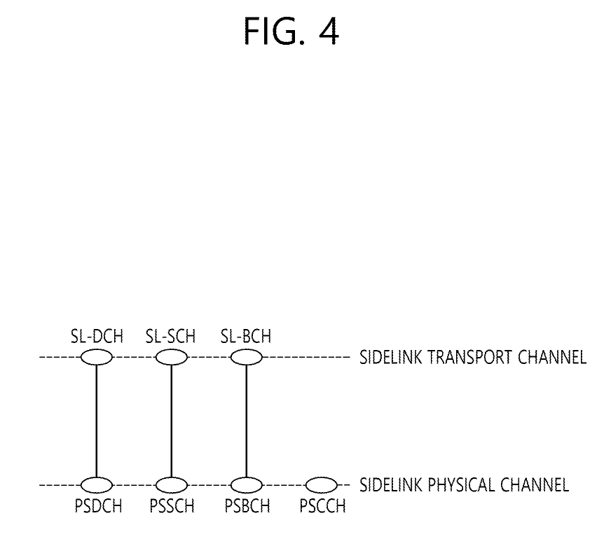

FIG. 4 shows mapping between sidelink transport channels and sidelink physical channels. Referring to FIG. 4, a physical sidelink discovery channel (PSDCH) carrying sidelink discovery message from the UE is mapped to a sidelink discovery channel (SL-DCH). A physical sidelink shared channel (PSSCH) carrying data from a UE for sidelink communication is mapped to a sidelink shared channel (SL-SCH). A physical sidelink broadcast channel (PSBCH) carrying system and synchronization related information, transmitted from the UE, is mapped to a sidelink broadcast channel (SL-BCH). A physical sidelink control channel (PSCCH) carries control from a UE for sidelink communication.

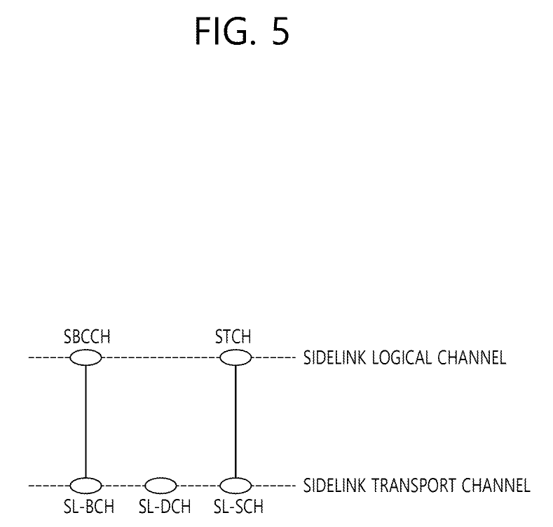

FIG. 5 shows mapping between sidelink logical channels and Sidelink transport channels. Referring to FIG. 5, SL-BCH is mapped to a sidelink broadcast control channel (SBCCH). The SBCCH is a sidelink channel for broadcasting sidelink system information from one UE to other UE(s). This channel is used only by sidelink communication capable UEs. SL-SCH is mapped to a sidelink traffic channel (STCH). The STCH is a point-to-multipoint channel, for transfer of user information from one UE to other UEs. This channel is used only by sidelink communication capable UEs.

Sidelink communication is a mode of communication whereby UEs can communicate with each other directly over the PC5 interface. This communication mode is supported when the UE is served by E-UTRAN and when the UE is outside of E-UTRA coverage. Only those UEs authorized to be used for public safety operation can perform sidelink communication.

In order to perform synchronization for out of coverage operation, UE(s) may act as a synchronization source by transmitting SBCCH and a synchronization signal. SBCCH carries the most essential system information needed to receive other sidelink channels and signals. SBCCH along with a synchronization signal is transmitted with a fixed periodicity of 40 ms. When the UE is in network coverage, the contents of SBCCH are derived from the parameters signaled by the eNB. When the UE is out of coverage, if the UE selects another UE as a synchronization reference, then the content of SBCCH is derived from the received SBCCH. Otherwise, UE uses pre-configured parameters. System information block type-18 (SIB18) provides the resource information for synchronization signal and SBCCH transmission. There are two pre-configured subframes every 40 ms for out of coverage operation. UE receives synchronization signal and SBCCH in one subframe and transmit synchronization signal and SBCCH on another subframe if UE becomes synchronization source based on defined criterion.

UE performs sidelink communication on subframes defined over the duration of sidelink control period. The sidelink control period is the period over which resources allocated in a cell for sidelink control information and sidelink data transmissions occur. Within the sidelink control period, the UE sends sidelink control information followed by sidelink data. Sidelink control information indicates a Layer 1 ID and characteristics of the transmissions (e.g. MCS, location of the resource(s) over the duration of sidelink control period, timing alignment).

The UE performs transmission and reception over Uu and PC5 with the following decreasing priority order:
Uu transmission/reception (highest priority);
PC5 sidelink communication transmission/reception;
PC5 sidelink discovery announcement/monitoring (lowest priority).

The UE supporting sidelink communication can operate in two modes for resource allocation. The first mode is a scheduled resource allocation. The scheduled resource allocation may be referred to as Mode 1. In Mode 1, the UE needs to be RRC_CONNECTED in order to transmit data. The UE requests transmission resources from the eNB. The eNB schedules transmission resources for transmission of sidelink control information and data. The UE sends a scheduling request (dedicated scheduling request (D-SR) or random access) to the eNB followed by a sidelink buffer status report (BSR). Based on the sidelink BSR, the eNB can determine that the UE has data for a sidelink communication transmission and estimate the resources needed for transmission. The eNB can schedule transmission resources for sidelink communication using configured sidelink radio network temporary identity (SL-RNTI).

The second mode is a UE autonomous resource selection. The UE autonomous resource selection may be referred to as Mode 2. In Mode 2, a UE on its own selects resources from resource pools and performs transport format selection to transmit sidelink control information and data. There can be up to 8 transmission pools either pre-configured for out of coverage operation or provided by RRC signalling for in-coverage operation. Each pool can have one or more ProSe per-packet-priority (PPPP) associated with it. For transmission of a MAC protocol data unit (PDU), UE selects a transmission pool in which one of the associated PPPP is equal to the PPPP of a logical channel with highest PPPP among the logical channel identified in the MAC PDU. There is one to one association between sidelink control pool and sidelink data pool. Once the resource pool is selected, the selection is valid for the entire sidelink control period. After the sidelink control period is finished, the UE may perform resource pool selection again.

A set of transmission and reception resource pools for sidelink control information when the UE is out of coverage for sidelink communication is pre-configured in the UE. The resource pools for sidelink control information when the UE is in coverage for sidelink communication are configured as below. The resource pools used for reception are configured by the eNB via RRC, in broadcast signaling. The resource pool used for transmission is configured by the eNB via RRC, in dedicated or broadcast signaling, if Mode 2 is used, and the resource pool used for transmission is configured by the eNB via RRC, in dedicated signaling if Mode 1 is used. The eNB schedules the specific resource(s) for sidelink control information transmission within the configured reception pools.

A set of transmission and reception resource pools for data when the UE is out of coverage for sidelink communication is pre-configured in the UE. The resource pools for data when the UE is in coverage for sidelink communication are configured as below. The resource pools used for transmission and reception are configured by the eNB via RRC, in dedicated or broadcast signaling, if Mode 2 is used. There is no resource pool for transmission and reception if Mode 1 is used.

Sidelink discovery is defined as the procedure used by the UE supporting sidelink discovery to discover other UE(s) in its proximity, using E-UTRA direct radio signals via PC5. Sidelink discovery is supported both when UE is served by EUTRAN and when UE is out of EUTRA coverage. Only ProSe-enabled public safety UE can perform sidelink discovery when it is out of EUTRA coverage. For public safety sidelink discovery, the allowed frequency is pre-configured in the UE, and is used even when UE is out of coverage of EUTRA in that frequency. The pre-configured frequency is the same frequency as the public safety ProSe carrier.

In order to perform synchronization, UE(s) participating in announcing of discovery messages may act as a synchronization source by transmitting a synchronization signal based on the resource information for synchronization signals provided in SIB19.

There are two types of resource allocation for discovery message announcement. The first type is UE autonomous resource selection which is a resource allocation procedure where resources for announcing of discovery message are allocated on a non UE specific basis. The UE autonomous resource selection may be referred to as Type 1. In Type 1, the eNB provides the UE(s) with the resource pool configuration used for announcing of discovery message. The configuration may be signaled in broadcast or dedicated signaling. The UE autonomously selects radio resource(s) from the indicated resource pool and announces discovery message. The UE can announce discovery message on a randomly selected discovery resource during each discovery period.

The second type is scheduled resource allocation which is a resource allocation procedure where resources for announcing of discovery message are allocated on per UE specific basis. The scheduled resource allocation may be referred to as Type 2. In Type 2, the UE in RRC_CONNECTED may request resource(s) for announcing of discovery message from the eNB via RRC. The eNB assigns resource(s) via RRC. The resources are allocated within the resource pool that is configured in UEs for announcement.

For UEs in RRC_IDLE, the eNB may select one of the following options. The eNB may provide a resource pool for UE autonomous resource selection based discovery message announcement in SIB19. UEs that are authorized for sidelink discovery use these resources for announcing discovery message in RRC_IDLE. Or, the eNB may indicate in SIB19 that it supports sidelink discovery but does not provide resources for discovery message announcement. UEs need to enter RRC_CONNECTED in order to request resources for discovery message announcement.

For UEs in RRC_CONNECTED, a UE authorized to perform sidelink discovery announcement indicates to the eNB that it wants to perform sidelink discovery announcement. UE can also indicate to the eNB, the frequency(s) in which sidelink discovery announcement is desired. The eNB validates whether the UE is authorized for sidelink discovery announcement using the UE context received from MME. The eNB may configure the UE with resource pool for UE autonomous resource selection for discovery message announcement via dedicated signaling. The eNB may configure resource pool along with dedicated resource in the form of time and frequency indices for discovery message announcement via dedicated RRC signaling. The resources allocated by the eNB via dedicated signaling are valid until the eNB re-configures the resource(s) by RRC signaling or the UE enters RRC_IDLE.

Authorized receiving UEs in RRC_IDLE and RRC_CONNECTED monitor resource pools used for UE autonomous resource selection and resource pools for scheduled resource allocation. The eNB provides the resource pool configuration used for discovery message monitoring on intra frequency, inter frequency of same or different PLMNs cells in RRC signaling (SIB19 or dedicated). The RRC signaling (SIB19 or dedicated) may contain detailed sidelink discovery configuration used for announcement of sidelink discovering in cells of intra-frequency, inter-frequency of same or different PLMNs.

Vehicle-to-everything (V2X) communication is described. V2X communication contains the three different types, i.e. vehicle-to-vehicle (V2V) communications, vehicle-to-infrastructure (V2I) communications, and vehicle-to-pedestrian (V2P) communications. These three types of V2X can use “co-operative awareness” to provide more intelligent services for end-users. This means that transport entities, such as vehicles, road side unit (RSU), and pedestrians, can collect knowledge of their local environment (e.g. information received from other vehicles or sensor equipment in proximity) to process and share that knowledge in order to provide more intelligent services, such as cooperative collision warning or autonomous driving.

V2X service is a type of communication service that involves a transmitting or receiving UE using V2V application via 3GPP transport. Based on the other party involved in the communication, it can be further divided into V2V service, V2I service, V2P service, and vehicle-to-network (V2N) service. V2V service is a type of V2X service, where both parties of the communication are UEs using V2V application. V2I service is a type of V2X service, where one party is a UE and the other party is an RSU both using V2I application. The RSU is an entity supporting V2I service that can transmit to, and receive from a UE using V2I application. RSU is implemented in an eNB or a stationary UE. V2P service is a type of V2X service, where both parties of the communication are UEs using V2P application. V2N service is a type of V2X service, where one party is a UE and the other party is a serving entity, both using V2N applications and communicating with each other via LTE network entities.

In V2V, E-UTRAN allows such UEs that are in proximity of each other to exchange V2V-related information using E-UTRA(N) when permission, authorization and proximity criteria are fulfilled. The proximity criteria can be configured by the mobile network operator (MNO). However, UEs supporting V2V service can exchange such information when served by or not served by E-UTRAN which supports V2X service. The UE supporting V2V applications transmits application layer information (e.g. about its location, dynamics, and attributes as part of the V2V service). The V2V payload must be flexible in order to accommodate different information contents, and the information can be transmitted periodically according to a configuration provided by the MNO. V2V is predominantly broadcast-based. V2V includes the exchange of V2V-related application information between distinct UEs directly and/or, due to the limited direct communication range of V2V, the exchange of V2V-related application information between distinct UEs via infrastructure supporting V2X Service, e.g., RSU, application server, etc.

In V2I, the UE supporting V2I applications sends application layer information to RSU. RSU sends application layer information to a group of UEs or a UE supporting V2I applications.

In V2P, E-UTRAN allows such UEs that are in proximity of each other to exchange V2P-related information using E-UTRAN when permission, authorization and proximity criteria are fulfilled. The proximity criteria can be configured by the MNO. However, UEs supporting V2P service can exchange such information even when not served by E-UTRAN which supports V2X service. The UE supporting V2P applications transmits application layer information. Such information can be broadcast by a vehicle with UE supporting V2X Service (e.g. warning to pedestrian), and/or by a pedestrian with UE supporting V2X Service (e.g. warning to vehicle). V2P includes the exchange of V2P-related application information between distinct UEs (one for vehicle and the other for pedestrian) directly and/or, due to the limited direct communication range of V2P, the exchange of V2P-related application information between distinct UEs via infrastructure supporting V2X service, e.g., RSU, application server, etc.

For V2X communication, especially, V2V communication, a SL resource on PC interface may be used. For efficient use of SL resources, a method in which a UE reports an occupancy of a SL resource may be required, and accordingly, the present invention proposes the method in which a UE reports an occupancy of a SL resource according to embodiments.

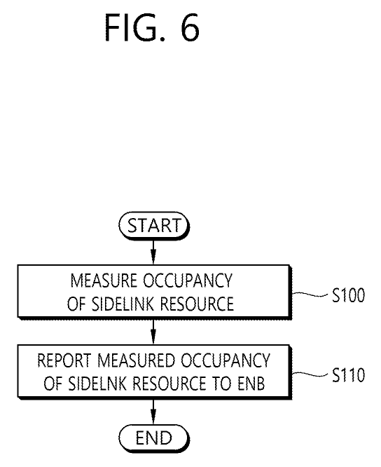

FIG. 6 illustrates a method of reporting an occupancy of a SL resource according to an embodiment of the present invention.

In step S100, a UE measures an occupancy of a SL resource. The occupancy of SL resource may indicate a SL congestion level. The occupancy of SL resource may be measured for a predetermined period. The occupancy of SL resource may be expressed as one of integers from 0 to 100. The occupancy of SL resource may be referred to as a channel busy ratio (CBR).

In step S110, the UE reports the measured occupancy of SL resource to an eNB. The measured occupancy of SL resource may be reported to the eNB when a specific event occurs. More particularly, the specific event may be the case where the occupancy of SL resource is greater or smaller than a threshold value. Alternatively, the occupancy of SL resource may be periodically reported to the eNB.

In this embodiment, the UE may be a vehicle UE. The UE may transmit a V2V message to another vehicle UE using the SL resource. Additionally, the UE may measure a SL channel quality, and report the measured SL channel quality to the eNB. The SL channel quality may be sidelink reference signal received power (RSRP).

Hereinafter, path selection and/or path switching will be described. The UE may select one of UL and SL based on the above measured occupancy of SL resource, and switch to the selected path.

3GPP is designed to support both PC5 transmission (that is, SL transmission) and Uu transmission (that is, UL transmission) of a V2X service. To this end, introduction of path switching between PC5 and Uu is being discussed for a V2V service. In this regard, various usage examples are considered. The path switching may need to be considered in a region used for V2V. In addition, in a region where PC5 and Uu are used for V2V, a vehicle may need to monitor both of PC5 and Uu, and thus, a path switching mechanism aims to switch a transmission path.

The following is various examples of path switching between PC5 and Uu.

(1) Lack of Capacity of PC5/Uu

A capacity of Uu or PC5 may not be sufficient during a rush-hour time, especially in a large city. Considering the insufficient capacity, an eNB may trigger path switching so as to offload a V2X message from one path to another path. For example, when a capacity of UL or DL is not sufficient for V2V, the eNB may offload a V2X message to PC5. When congestion frequently occurs in PC5, the eNB may offload a V2X message to Uu. In these usage examples, path switching needs to be controlled per cell. The path switching may be performed when both PCV and Uu are used for V2V, and thus, path switching on a unit basis of each cell may be supported. In addition, the eNB needs to be able to offload a part of the V2X message, transmitted by the UE, from one path to another path in a cell.

(2) Coexistence with Dedicated Short Range Communication (DSRC)

DSRC/IEEE 802.11p service using the same channel as that of PC5 transmission for V2V service may coexist. Path switching may be one of solutions for this coexistence. For example, when a UE detects the coexistence or when a network is aware of potential coexistence with DSRC in a predetermined region, Uu transmission for V2u may be selected depending on determination by an eNB.

(3) Connection Failure or Out-of-Coverage (OOC)

When a UE moves to OOC or IDLE, UL transmission is not possible. In addition, when a UE detects a radio link failure (RLF) or a handover failure (HOF), UE transmission is not possible. Thus, in these cases, it is necessary to switch to PC5. Meanwhile, in this usage example, for V2V transmission, a UE may select or reselect one of PC5 transmission or Uu transmission, for example, on the basis of a standard provided by an eNB. This usage example is useful when coping with an abnormal situation.

In all usage examples, path switching may not occur often. However, a vehicle travelling in the highway may change a cell often, for example every few seconds, and thus, when an adjacent cell selects another path, path switching may occur whenever a cell is changed.

In the assumption that a selected path is determined and that a UE is still able to transmit a V2X message via a previous path, it may not be necessary to quickly switch to the selected path in the above-described first usage example and the above-described second usage example. However, since a UE is not capable to perform UL transmission during OOC, IDLE, HOF, or RLF, the UE may need to quickly switch to a new path, that is, PC5, in the above-described third usage example so as to prevent message loss.

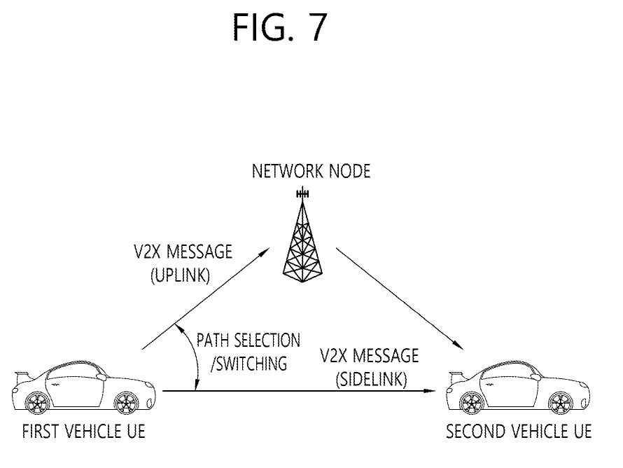

FIG. 7 illustrates the case where a path of a V2V message is switched according to an embodiment of the present invention. Referring to FIG. 7, a first vehicle UE may transmit a V2V message using a UL to a network node (e.g., an eNB). The network node may transmit the received V2V message to a second vehicle UE. Alternatively, the first vehicle UE may transmit a V2V message directly to the second vehicle UE using an SL. One of an UL and an SL may be selected as a path along which the first vehicle UE transmits a V2V message. In addition, when a V2V message is being transmitted using one path and when another path is selected, the path for transmission of the V2V message may be switched to the selected path.

E-UTRAN may select a path between PC5 and Uu to transmit a V2V message within network coverage. The above-described first usage example and the above-described second usage example may be supported by path selection by the E-UTRAN. Meanwhile, it may be necessary for a UE to autonomously select a path in order to support the above-described third usage example and/or the above-described second usage example. Accordingly, a path may be selected by an eNB or a UE which transmits a V2X message, and, in the case where the UE selects a path, the path selection may be performed on the basis of a standard provided by a network. Path switching based on path selection may be performed by the UE.

When the eNB selects path, the eNB may use its own information. For example, when SL transmission is scheduled by the eNB, the eNB is able to be aware of a shortage of Uu resources and a shortage of PC5 resources, and thus, the eNB may select a path using its own information. Considering a traffic congestion level, the eNB may select a path based on static or semi-static configuration. That is, the eNB may indicate path selection by transmitting a network command to the UE. For example, the eNB may control path selection for each UE using UE-dedicated signaling. The UE-dedicated signaling may be RRC signaling or PDCCH grant (which is an SL grant or a UL grant for semi-persistent scheduling). Alternatively, the UE may control path selection for each cell based on system information. In this case, the path selection may be based on a probability (e.g. 100:0 or 60:40). The probability may be configured for each subcarrier. The system information may include a SL quality threshold value.

In addition, for path selection, the UE may report some information to the eNB. In PC5 V2V, a semi-persistent detection function for UE autonomous resource selection may be supported. Accordingly, through sensing, a vehicle is able to report information on a PC5 resource state to the eNB. The information on a PC5 resource state may be an occupancy of a SL resource described above in FIG. 6. In addition, the UE may report an SL quality (and/or a Uu quality) to the eNB. In addition, when SL transmission is based on Mode 2 operation, the UE may report coexistence with DSRC or SL congestion. It is because the eNB is not able to notice coexistence with DSRC in some regions, such as a region in vicinity of the border. Given the fact that a plurality of V2X message would be possibly lost due to congestion, such reporting by the UE may be essential for a V2X service in consideration of importance of the V2V service. In addition, the UE may report geographical information (e.g. a location of a vehicle) to the eNB for PC5 V2V. If UE reporting is supported, the eNB needs to configure a V2X-related report from the UE at least for the purpose of path selection.

The above-described UE reporting may be performed when a predetermined event occurs. For example, similarly to A3 event, when Uu RSRP in a neighboring cell is greater or smaller than the current Uu RSRP by X dB or when SL RSRP in a neighboring cell is greater or smaller than the current SL RSRP by Y dB, the UE reporting may be performed. Alternatively, similarly to A1/A2 event, when Uu RSRP is greater or smaller than a threshold value or when SL RSRP is greater or smaller than a threshold value, the UE reporting may be performed. Such UE reporting may be performed periodically.

When path selection is performed by the eNB, the eNB may indicate a path selected for one or more UEs. This indication may be performed using system information or UE-dedicated signaling. Considering the above usage example, an indication in the system information may need to directly indicate a path selected for every vehicle in a cell or to indicate some vehicles with respect to each path.

Meanwhile, the UE may autonomously select a path, considering a link quality and a traffic congestion level. That is, the UE may autonomously select a path based on at least one of a SL quality or a SL congestion level (that is, an occupancy of SL resource). The UE may be capable of autonomously receive a path only when receiving a handover command or when detecting or declaring RLF/HOF (e.g. when an RLF/HOF-related timer expires).

After the above-described path selection, the UE may perform path switching to a path (that is, an SL or an UL) selected for V2X transmission.

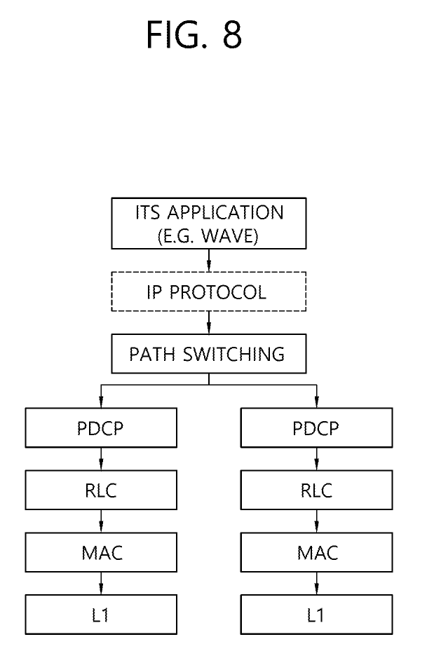

FIG. 8 illustrates a model for path switching in a UE according to an embodiment of the present invention. Referring to FIG. 8, path switching is performed on a new layer (e.g. an access network discovery and selection function (ANDSF) or LTE wireless local area network (WLAN) radio level integration with IPsec tunnel (LWI) for LTE/WLAN interworking) between an ITS application layer and a PDCP layer. Since a security function varies between an SL and an UL, it may be desirable to perform path switching right over the PDCP layer. The new layer for performing path switching may perform another function in addition to path switching. The new layer for performing path switching may identify an RB for local channel prioritization (LCP). That is, the new layer for performing path switching may identify a message type, such as a periodic message and an event trigger message. Alternatively, the new layer for performing path switching may identify a priority of a PPPP or a quality of service (QoS). The priority may be related to LCP and resource pool selection. That is, the new layer for performing path switching may identify a message type and/or a UE type, for example, a vehicle UE, an urgent UE (e.g. a fire engine in an emergency situation, a police car in a tracing situation), a UE-type RSU, and a pedestrian UE.

Service stopping needs to be minimized during path switching or movement. To this end, in the case of path switching, a V2V message may be transmitted both on an UL and an SL at the same time. In the case of handover, not just PC5 synchronization configuration, but also a PC5 resource of a target cell (including an RX resource pool) may be informed to a UE via a handover command.

In the case of cell reselection, it may be required to reduce a time for acquiring SIB18. To this end, a UE, which operates in Mode 1 in RRC_CONNECTED, may receive an RX resource pool to be used in a target cell and assignment of an SL SPS resource through a handover command. Alternatively, until receiving a TX/RX resource pool from a target cell through system information, the UE may keep using an RX resource pool of a source cell and an SL SPS resource. A UE, which operates in Mode 2 in RRC_IDLE and RRC_CONNECTED, may use a location-based TX/RX resource pool through system information for a serving cell and a neighboring cell within a frequency or between frequencies. Alternatively, until receiving a TX/RX resource pool through system information from a target cell, the UE may keep using a TX/RX resource pool of a source cell.

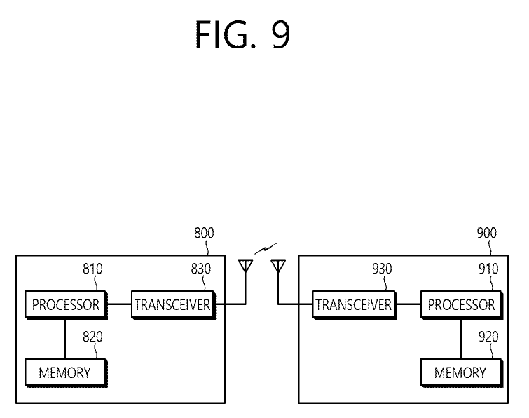

FIG. 9 shows a wireless communication system to implement an embodiment of the present invention.

An eNB 800 includes a processor 810, a memory 820 and a radio frequency (RF) unit 830. The processor 810 may be configured to implement proposed functions, procedures and/or methods described in this description. Layers of the radio interface protocol may be implemented in the processor 810. The memory 820 is operatively coupled with the processor 810 and stores a variety of information to operate the processor 810. The RF unit 830 is operatively coupled with the processor 810, and transmits and/or receives a radio signal.

A UE 900 includes a processor 910, a memory 920 and an RF unit 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The RF u nit 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The RF units 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope of the present disclosure.

What is claimed is:

1. A method for reporting an occupancy of a sidelink (SL) resource by a user equipment (UE) in a wireless communication system, the method comprising:
measuring the occupancy of the SL resource; and
reporting the measured occupancy of the SL resource to an eNodeB (eNB).

2. The method of claim 1, wherein the measured occupancy of the SL resource is reported to the eNB when a specific event occurs.

3. The method of claim 2, wherein the specific event is a case that the measured occupancy of the SL resource is greater than a threshold value.

4. The method of claim 2, wherein the specific event is a case that the measured occupancy of the SL resource is lower than a threshold value.

5. The method of claim 1, wherein the measured occupancy of the SL resource is reported to the eNB periodically.

6. The method of claim 1, wherein the occupancy of the SL resource is measured during a pre-determined interval

7. The method of claim 1, wherein the occupancy of the SL resource is one of an integer from 0 to 100.

8. The method of claim 1, wherein the occupancy of the SL resource is a channel busy ratio (CBR).

9. The method of claim 1, wherein the UE is a vehicle UE.

10. The method of claim 1, further comprising transmitting a vehicle-to-vehicle (V2V) message to another vehicle UE via the SL resource.

11. The method of claim 1, further comprising selecting one path among an uplink (UL) and a SL based on the measured occupancy of the SL resource.

12. The method of claim 11, further comprising switching a path based on the selected one path.

13. The method of claim 1, further comprising:
measuring quality of a sidelink channel; and
reporting the measured quality of the sidelink channel to the eNB.

14. The method of claim 13, wherein the quality of the sidelink channel is a sidelink reference signal received power (SL-RSRP).

15. A user equipment (UE) in a wireless communication system, the UE comprising:
a memory;
a transceiver; and
a processor, operably coupled to the memory and the transceiver, that:
measures an occupancy of a sidelink (SL) resource; and
controls the transceiver to report the measured occupancy of the SL resource to an eNodeB (eNB).
